(19) United States
(12) Patent Application Publication
(10) Pub. No.: US 2024/0328075 A1
(43) Pub. Date: Oct. 3, 2024

(54) NOVEL METHOD OF PRODUCING A BIO BASED TEXTILE MATERIAL AND PRODUCTS MADE THEREBY USING REGENERATED CELLULOSIC MATERIALS

(71) Applicant: ISA TanTec Limited, em Macau SAR (CN)

(72) Inventors: Thomas SCHNEIDER, Heshan Guangdong Province (CN); Reiner HENGSTMANN, Thanh pho Ho Chi Minh (VN)

(73) Assignee: ISA TanTec Limited, em Macau SAR (CN)

(21) Appl. No.: 18/622,402

(22) Filed: Mar. 29, 2024

Related U.S. Application Data
(60) Provisional application No. 63/455,684, filed on Mar. 30, 2023.

(51) Int. Cl. D06M 15/05; D06M 15/705; D06M 15/71; D06M 101/06

(52) U.S. Cl. CPC D06M 15/05; D06M 15/705; D06M 15/71; D06M 2101/06

(57) ABSTRACT

The present invention is directed to a system and method of producing different bio-based and coated textile composite materials. These bio-based textile composite materials may be used for products in various industries such as, footwear, automotive and accessories. In the system and method described herein, coatings are applied to a backing comprised of regenerated cellulosic materials, with the coatings and the backing further treated to produce a bio-based textile composition.

### CROSS-REFERENCE TO RELATED APPLICATIONS

This applications claims priority to U.S. Provisional Application No. 63/455,684, filed Mar. 30, 2023, the contents of which are hereby incorporated by reference in their entirety.

### FIELD OF THE INVENTION

The present invention relates to a system and method of producing different bio-based and coated textile composite materials and products thereby. These bio-based textile composite materials may be used for products in various industries such as textiles, footwear, automotive covers, and accessories. In particular, the present invention relates to a method of producing different bio-based textile materials using coatings applied to a backing material. The backing material may be comprised of regenerative cellulosic fibers, which can be viscose and/or lyocell, and which can be pure fibers and/or mixed fibers with different ratios. The cellulose fiber may be man-made regenerative cellulosic fiber, and is preferably as close to one hundred percent bio-based and biodegradable as possible, and may, for example be manufactured from materials obtained from certified sustainable managed forests. These certified sustainable forests may be, for example, those certified by the Forest Stewardship Counsel or other agencies that certify and manage sustainable forests. One or more coatings can be applied to the backing material, with the coatings and backing material being further treated during and after the application of the one or more coatings to produce a bio-based textile composition.

### BACKGROUND OF THE INVENTION

There is growing environmental awareness and social concerns about the environmental impact of the textile industry, underscoring the growing need to develop green and sustainable approaches throughout this industry's supply chain. Upstream, new sustainable raw materials and processes must be found due to population growth and the increasing consumption of textile fibers within the apparel, footwear, and automotive industry.

What is needed is a process to create and manufacture alternatives to existing crude oil-based materials which do not harm the environment and negatively contribute to the global climate change.

### SUMMARY OF THE INVENTION

The present invention is directed to systems and methods for creating different bio-based and coated composite textile materials. The systems and methods include creating bio-based textile materials by applying coatings onto backing materials. The backing materials may be, for example, man-made or naturally occurring regenerative cellulose backings. The resulting bio-based textile materials may be used, for example, as alternatives to textiles made from crude oil-based polymers commonly used in the textile, footwear, and automotive industries. The replacement of synthetic polymeric materials with regenerative materials and other bio-based materials helps to move towards increasing sustainability in the consumer goods industry. In particular, the present invention uses regenerative cellulosic materials to make high-performance products, with some products including additional chemicals to enhance different properties of the resulting textile material. These additional chemicals may include, for example, water-based polyurethane, water based acrylics and biobased polymers as well as water based butadiene which may be added to the backing material in one or more applied coatings. The backing material may act as a reinforcement backing, and may be a woven or non-woven man-made regenerated cellulosic fiber made of, for example, viscose, lyocell, modal and/or any other cellulose based non-woven fabric. The coatings may be applied to the backing material as separate layers, with the backing and any applied coating layers being allowed to dry and set before any subsequent layers are applied, if required. The system and method may further include pressing or flattening the non-woven backing material and any applied coating layers before, during, or after such layers are dried and set. The coating layers may also include, for example, bio based color pigments or dyes to produce a desired color or patterns in the final product.

The cellulose-based regenerative, man-made cellulosic fibers are preferably sourced from certified sustainable managed forests. Such forests may be those certified by the Forest Stewardship Council or similar agencies that use their expertise to promote responsible management of the world's forests by bringing together experts from the environmental, economic and social areas. These certified sustainable managed forests are carbon neutral with every tree that is cut being replaced with additionally planted trees. The use of such certified materials in consumer goods allows the customer to trace where the material comes from based on assigned tracking information. This tracking information is included with shipments of any materials harvested from the forest.

The method and system use the regenerative cellulosic fibers to produce a textured reinforcement backing material. As noted above, the regenerative cellulosic fiber blend may be made from viscose and lyocell and is considered bio-based and bio-degradable. In addition, the regenerative cellulosic fiber blend forming the reinforcement backing material may be made such that it does not contain any additional synthetic fibers to add additional material strength. The reinforcement backing material may have an area density to provide sufficient strength and permeability for use in consumer textile products. The reinforcement backing material may have varying densities which may apply for different final applications, one example being an area density of around 500 g/m². This reinforcement backing material may be created through a needle punching process and/or hydroentanglement process to create a non-woven backing material. Needle-punched non-woven fabrics can be made from various fibrous webs, fiber entanglement and frictions after fine needle barbs are repeatedly penetrated through fibrous web. The needle punched fabrics have a fibrous network with the non-woven fabrics providing specific functions including for example, resilience, stretch and softness. The non-woven fabric can also be made by hydroentanglement, where fibers are subjected to high pressure water streams, joining them together. The reinforcement backing material serves as an enforcement/backing material in the production of manufactured products. In the system and method described herein, the bio-based, natural composite materials are applied to the reinforcement backing material in one or more coating layers, resulting in a bio-based and substantially biodegradable textile material that provides high performance in consumer industries, such as the footwear industry.

The system and method may be used to make high performance products, with some products including additional chemicals to enhance certain properties thereof. For example, to create a high performance textile product, chemicals such as polyurethane and butadiene may be added to the regenerated cellulose for the one or more coatings applied to the backing material.

As described herein, the system and method can create materials for use in the footwear, apparel and automotive industry and minimizes carbon footprint and the consumption of relevant performance indicators such as water and electricity.

### BRIEF DESCRIPTION OF THE INVENTION

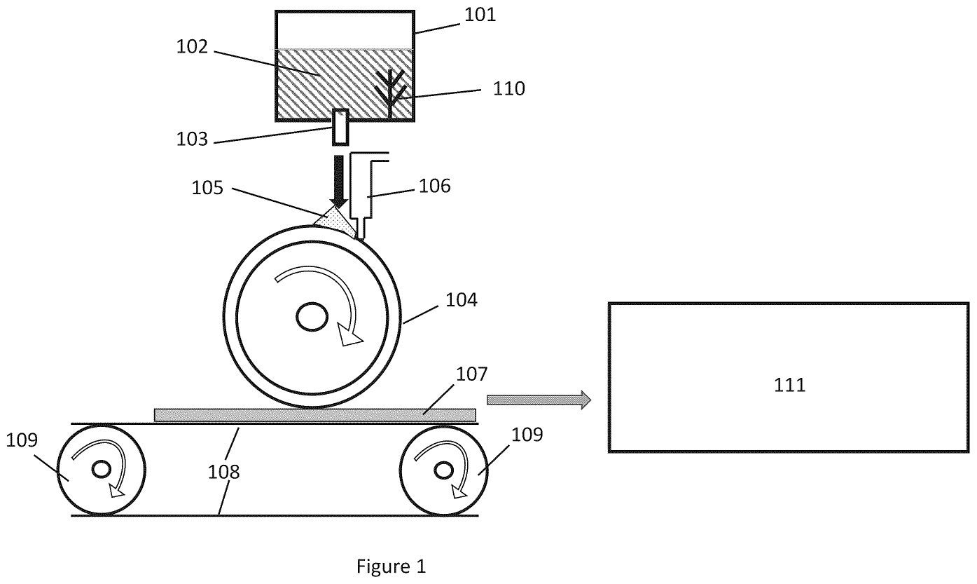

FIG. 1 illustrates the general principle of a roller coater system.

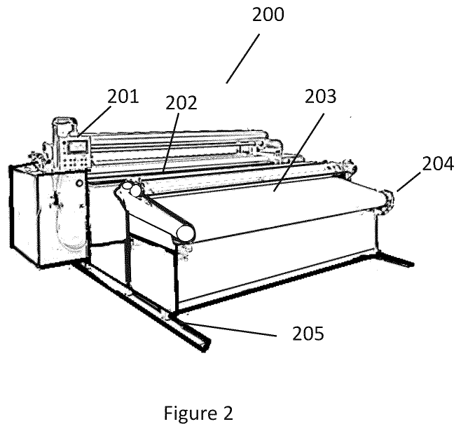

FIG. 2 illustrates an exemplary roller coater.

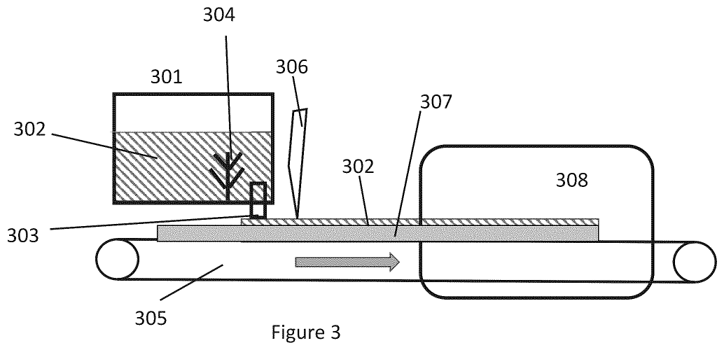

FIG. 3 illustrates base coated reinforcement backing material with slurry after the first treatment step.

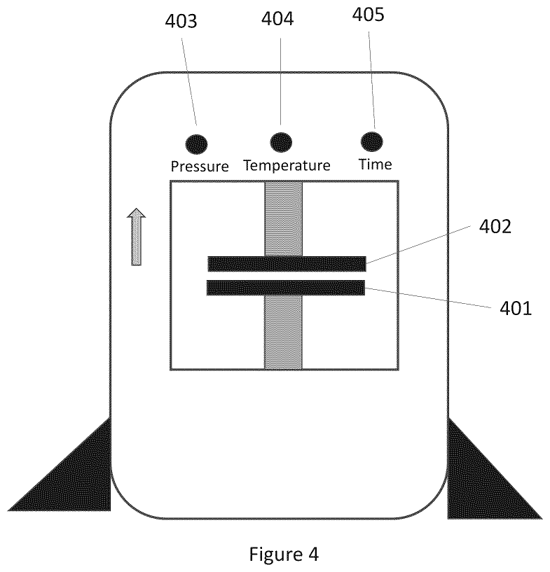

FIG. 4 illustrates an embossing machine which is used to press or flatten the surface of the reinforcement backing material with the base coat.

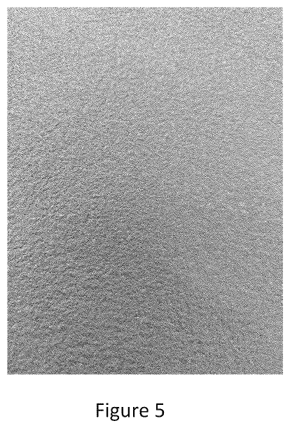

FIG. 5 shows an example of the construction of the coated material with the reinforcement material.

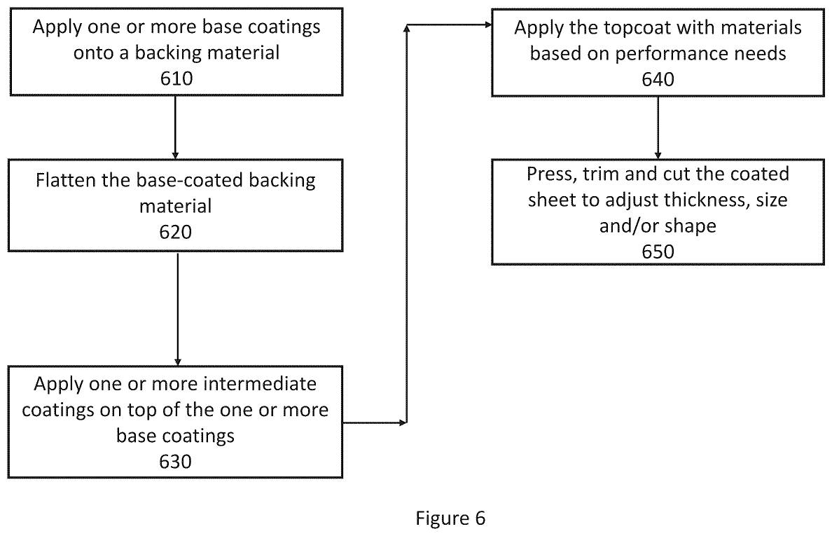

FIG. 6 provides a flow diagram of the process of creating a coated fabric as described in the process made of regenerative cellulose.

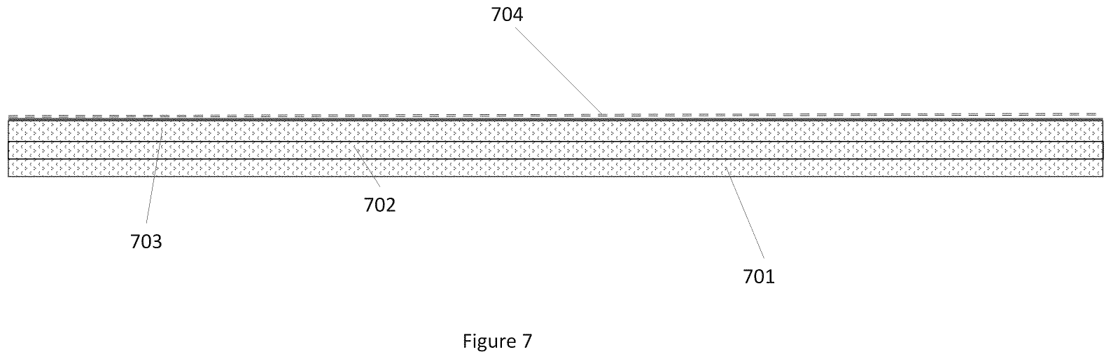

FIG. 7 illustrates an example of a fully coated reinforcement backing.

### DETAILED DESCRIPTION OF THE INVENTION

The system and method described herein implements a process directed to creating a bio-based material by applying a coating slurry on a reinforcing backing material, such as a regenerative cellulose backing fabric. The resulting product may be used to produce footwear and other consumer goods, including for the automotive industry. As described herein, the reinforcement backing may be a non-woven man-made cellulosic fiber made of viscose, lyocell, modal and/or any other cellulose based non-woven fabric in various blend ratios, or it may be a woven material produced from natural and sustainable fibers.

One or more coatings are created and applied to the reinforcement backing material. These coatings may be applied in different steps as separate layers, with each coating layer allowed to dry or set before application of the next coating layer. Certain of the layers, such as the intermediate layer, may contain performance supporting chemicals and bio-based color pigments or dyes. Other layers, such as the finishing layer, may include water-based or bio-based performance ingredients to provide desired performance and appearance characteristics to the final product. The layers, and in particular the base coating layer, may be pressed and flattened before a subsequent coating layer is applied. After all coating layers have been applied and set, the thickness, size, shape, and amount of the resulting material comprised of the reinforcement backing material and all applied coating layers may be adjusted. For example, the resulting material may be pressed, trimmed, or cut to a desired shape, size, and thickness.

As a first step in the process, a base-coating may be prepared and a base reinforcement backing material provided. The base-coating may then be applied to the reinforcement backing material on one side. The base coat may be created by combining ingredients including performance providing substances, such as bio-based polyurethanes, water-based polymers, water, pigments or dyes to create a slurry for high performance characteristics. The base coat may include, for example, bio-based polyurethanes in an amount of >60% of the bio based materials forming the coat. Additional bio polymers which can be used are made out of 100% plant based proteins. These high performance characteristics can, for example, include, high tear strength of up to 60 N, tensile strength of up to 90 N/cm2, vamp flex cycles of 200,000 to 500,000 cycles and Bally Flex cycles up to 50,000 and requirements for materials used in the automotive industry. Alternatively, or in addition, performance enhancing bio-based chemicals may also be added to the slurries used in the intermediate and finishing coatings described herein, or to the final textile product. The base-coat slurry may be created through combination of ingredients which are added into a mixing bowl in desired rations and in a desired order. All ingredients are mixed, including the water-and bio-based performance chemicals, natural plasticizer and pigments or dyes, which are mixed together at the same time. A mixer, such as an air pressured mixer, is used to mix the slurry until a homogenous solution is reached. Other mixers and devices can be used to mix the slurry including, for example a hydraulic mixer, mechanical mixer, agitator, or stirrer. This base-coat slurry is then applied to the reinforcement backing material, which may be a regenerated cellulose backing material. The base-coat slurry may be applied using, for example, a roller coater machine, doctor blade, brushes, or other application devices that spread the coating on the regenerative cellulose backing material. The base-coat slurry may be continuously mixed as it is applied using these systems. For example, when using a roller coater, the base-coat slurry may be continuously mixed as it is added to the roller coater machine. One or more base coatings may be applied to the reinforcement backing material to achieve the desired thickness of properties of the reinforcement backing material with the applied slurry. The formulation of the topcoat solution will vary based on the performance expectations of the final material, such as color requirements and surface structure requirements achieved by embossing-After the topcoat is applied to the sheet material comprising the reinforcement backing and coating layers applied thereto, the sheet material may be allowed to dry or set. Once complete, the final sheet material may be pressed, trimmed, or cut to adjust the thickness, size, and shape.

The pressing or flattening of the base-coated reinforcement backing material is done to level and even the surface while preparing for the next treatment and application of additional coating layers. For example, following application of the one or more base-coating layers and any pressing or flattening, the resultant base-coated reinforcement backing material may be prepared for application of one or more additional, intermediate coating layers. The intermediate coating layers may be applied using the same techniques as described above with respect to the base-coatings and may add a thin layer of material. After the one or more intermediate coating layers have been applied and dried or set, the sheets of material comprised of the reinforcement backing and any applied base and intermediate coating layers are prepared for application of final topcoats and additives. The formulation of the topcoat solution will vary based on the performance expectations of the final material, such as color requirements and surface structure requirements achieved by embossing. After the topcoat is applied to the sheet material comprising the reinforcement backing and coating layers applied thereto, the sheet material may be allowed to dry or set. Once complete, the final sheet material may be pressed, trimmed or cut to adjust the thickness, size, and shape. For example, the thickness may be adjusted based on different requirements of the products which will be made using the sheet material. To adjust the thickness, the material may be pressed, with the applied pressure condensing the backing material until the material is at a desired thickness. The thickness can also be adjusted by pressing the backing material before coatings are applied, such that the backing material is of the desired thickness when it is coated.

FIG. 1 illustrates an exemplary roller coater system that may be used to apply one or more of the coating layers as described above. As shown in FIG. 1, the roller coater system may include a container 101 for holding the coating slurry 102. A nozzle or valve 103 may be included on the slurry container, allowing a controlled amount of slurry to flow from the container. The nozzle or valve may be connected to a controllable pump allowing a user to adjust the amount of slurry coating dispensed. An application coating roller 104 is provided, which is controllable to rotate at various speeds and to contact a reinforcement backing substrate sheet 107 with an adjustable amount of pressure. The valve or nozzle 103 dispenses the slurry coating 102 from the container 101 onto the coating application roller 104 and creates a pocket of slurry coating called a slurry pocket 105. The slurry pocket 105 is picked up by the coating application roller 104. One or more scraper blades 106 may be included to remove excess coating from the back of the roller 104 and return it to the slurry pocket 105. The thickness of the coating the coating application roller 104 applies to the reinforcement backing material sheet 107 depends on the amount of coating released from the nozzle 103, and can further be adjusted based on the distance between the scraper blade 106 and the roller and/or the amount of pressure applied to the roller by the scraper blade. A conveyer 108 driven by one or more conveyer drive rollers 109 or other drive mechanisms moves the reinforcement backing material sheet 107 under the coating application roller 104. The application coating roller 104, which picks up slurry from the slurry pocket 105, transfers the slurry as a coating layer onto the backing material sheet 107 and compresses it into the sheet as it passes under the coating roller 104. The conveyer 108 may move the sheet 107 to an exit or holding area after the coating layer has been applied. Alternatively, the reinforcement backing material sheet 107 to be coated may itself be directly transported by conveyer rollers 109 so that it passes underneath the coating roller 104. In order to keep the slurry coating 102 in the container 101 substantially homogenous, a mixer 110 may be included in the slurry container. Once the sheet 107 is coated, it may be transitioned into a drying mechanism 111, such as a tunnel oven. The sheet is left in the drying mechanism until the water content of the sheet has been reduced to an acceptable amount for further processing. For example, the sheet may be left in a tunnel oven at a temperature set to remove water and start the polymerization process of the latex in the slurry coating. For example, the oven may be set to a temperature within a range of 85° C. to 140° C. Other drying temperatures, and different drying times, may be used to remove or reduce the remaining water. After the drying process, the treated sheets may be hung to ensure the sheets are sufficiently dry for the next processing steps.

FIG. 2 illustrates another view of a roller coater system 200 that may be used to apply the one or more coating layers. As shown in FIG. 2, the system may include a control panel with touch screen 201, a squeegee blade with linear insertion device 202 configured to dispense and apply the coating, and a working area 203 with a conveyer system. The system may further include one or more drive motors 204 configured to operate rollers to move materials placed on the working area 203. The system may be mounted on rails 205, such that the position of the working area relative to the coating application system and squeegee can be adjusted.

FIG. 3 illustrates an exemplary doctor blade application system which can be used to apply the one or more coatings and coating slurries as described above. As shown in FIG. 3, a container 301 may be provided that contains the slurry coating 302. A valve or nozzle 303 may be included on the container 301, allowing a controlled amount of the slurry coating 302 to be dispensed. A mixer 304 may be included in the container 301, in order to maintain a homogeneous consistency of the slurry coating. The slurry coating 302 may be dispensed into a coating area onto a conveyer system 305, and a doctor blade 306 may be positioned above the conveyer system 305. A reinforcement backing material sheet 307 may be provided on the conveyer system, which transports the reinforcement backing material sheet 307 in a direction such that it passes under the dispensing valve or nozzle 303 and also under the doctor blade 306. The doctor blade 306 removes excess dispensed coating from the sheet 307, allowing a desired amount of the coating to be transferred to the sheet 307 and compressed into the sheet. In some embodiments, the sheet 307 may be kept stationary, with the doctor blade 306 moved over the sheet to remove excess coating material. After the coating is controllably applied using the doctor blade 306, which may be adjustable in height to allow varying amounts of coating to be applied, the sheet 307 may pass into a heating and drying device 308, such as a tunnel oven. After the coating and drying process, the material may be hung to dry the sheet and reduce the moisture content before further processing steps. For example, the sheet may be hung to dry for up to 8 hours.

FIG. 4 illustrates an example of an embossing machine which may be used to flatten the surface of the reinforcement backing material with the base coat applied. Using this machine, the layers, and in particular the base-coating layer applied to the reinforcement backing material, may be pressed, and flattened so they are level and even before a subsequent coating layer is applied. As shown in FIG. 4, the embossing machine may include two plates 401, 402 that can be used to apply a controlled amount of pressure on the backing material sheets. The machine may further include inputs to allow a user to adjust the pressure 403, temperature 404, and time 405 of the embossing machine. When in use, a temperature and a pressure value are selected, and the sheet material is inserted into the machine and between the plates. The temperature and pressure are then applied for a selected time period with the desired side of the sheet facing up to flatten the base coated reinforcement material and prepare for the intermediate coating step. For example, a sheet of reinforcing material with the coated side facing up may be placed between the embossing plates 401 and 402 of FIG. 4, and a pressure (kg/cm²) 403 may be applied at a temperature of 80° C. to 110° C. 404 while the upper embossing plate is moving up on the material for a fixed time.

After the base-coated reinforcement backing material has been compressed and flattened, the surface is smooth and leveled. FIG. 5 illustrates an example of such a reinforcement backing material with a base coat applied after it has been compressed and flattened. As shown in the figure, the coated sheet of material has a smooth, evenly coated surface.

FIG. 6 illustrates a flow diagram of the procedural steps for creating a coated bio based textile product according to the systems and methods described herein. As shown in FIG. 6, the process begins in step 610 with the application of a base coating onto a reinforcement backing material sheet. The base coating is applied as a slurry coating, using, for example, one or more of the systems as described with respect to FIGS. 1-3. The base coating is applied to one or more sides of the backing material. After the application of the slurry as a base coat to the backing material, the base coated backing material is dried using a drying mechanism, such as a tunnel oven or air dryer. For example, to ensure the base-coated sheet is sufficiently dry, a reaction/drying time of at least fifteen minutes may be set with a tunnel dryer system that includes an oven capable of applying a temperature between 50° C. to 150° C. Other drying temperatures and drying techniques may be used to reduce the water content to an acceptable amount. When coating both sides, the coating process described above to apply a base coat is applied to one side of the fabric sheet, which is then dried. Then, this same process may then be repeated on the other side of the fabric sheet. In order to avoid contamination or dirtying the first coated side, a sheet or other protective cover may be applied to any conveyer system or on the first coated side such that the first coated side is protected as the second side is coated. Once the base-coating process is successfully completed, the material is hang-dried by hanging the material at room temperature for a final drying. This hand-drying process may last at least a few hours until the moisture content is significantly decreased.

As shown in the flow diagram of FIG. 6, once the materials have reached the minimum required moisture content, the process moves to step 620. In step 620, the surface of the sheet material with the base coats applied is flattened by using a pressing machine or embossing machine. This intermediate flattening process allows for the surface material to be leveled and evened while preparing for the next treatment step at 630. The base coated materials may be pressed, such as with an embossing machine applying a temperature and pressure with the desired side facing up. After the base-coated sheet is pressed and dried, the process moves to step 630 where one or more intermediate coatings are then applied. The intermediate coatings may be applied as a thin layer on top of the one or more base coatings. The application of the intermediate coatings may be performed in the same manner as the process for applying the base coats as discussed above. The coated sheets are then prepared for further processing in step 640.

Step 640 of FIG. 6 is directed to the application of the final coat, also known as the topcoat. The formulation of the topcoat is based on the desired performance needs of the final materials. The main ingredients and supporting agents of the topcoat include water-based polyurethane (bio-based) and other performance giving water-based substances. For example, short chain polymers or modified silica compounds may be included. The top coat provides final sealing of the surface of the material. The application of the final top-coat is applied either by using an industry spray application line with a drying tunnel directly attached thereto, or a roller printing application system and drying system. Test results of the performance of the materials suggest that good results can be achieved with an application of the topcoat with amounts of up to, for example, around 10 grams per square feet. After the final topcoat is applied and set, the coated sheet may then be trimmed and cut at step 650 to the desired size and shape. The material may also be pressed to adjust the thickness, and to achieve a desired surface pattern.

FIG. 7 shows an example of the construction of a fully coated reinforcement backing. As shown in the figure, there is a layer of reinforcement backing material 701, such as regenerative non-woven cellulose material or woven cellulose material, which is coated and penetrated with a first base coat 702 and an intermediate coat 703. The base coat 702 may be applied on one or both sides, and the intermediate coat layer may be applied on top of the base coat. When both sides are base coated, the intermediate layer can be selectively applied to one or both of the base coated sides. Finally, a topcoat layer 704 is applied on top of the intermediate layer. When both sides contain an intermediate layer, the topcoat may be applied to one or both of the intermediate layered sides. The topcoat 704 can be applied through a roller coater system or a spray carousel.

1. A method for producing a bio-based textile material, comprising:
applying a first coating to a reinforcement backing material with regenerative cellulosic material;
drying the reinforcement backing material with the first coating;
flattening a surface of the reinforcement backing material with the first coating;
applying a second coating to the reinforcement backing material, wherein the second coating is applied on top of the first coating;
drying the reinforcement backing material with the first coating and the second coating;
applying a third coating to the reinforcement backing material, wherein the third coating is applied on top of the second coating, with the first coating, second coating and third coating comprising separate layers; and
adjusting the thickness of the reinforcement backing material.

2. The method of claim 1, wherein at least one of the first coating, second coating and third coating comprise regenerative cellulosic material which is combined with at least one of water-based polyurethane, water based acrylics, biobased polymers and water based butadiene.

3. The method of claim 1, wherein the reinforcement backing material is a woven or a non-woven cellulose based fabric.

4. The method of claim 1, further comprising wherein the thickness of the reinforcement backing material is adjusted by pressing the backing material.

5. A system for creating a bio-based sheet textile material, comprising:
a regenerative cellulose backing material comprising regenerative cellulosic material;
a roller coater system for applying a first coating, a second coating and a third coating to the regenerative cellulose backing material,
the first coating applied on at least one side of the regenerative cellulose backing material;
a drying mechanism for drying the regenerative cellulose backing material with the first coating;
an embossing machine for flattening a surface of the regenerative cellulose backing material with the first coating; and
the second coating including a slurry containing at least one bio-based performance chemical and wherein the second coating is applied on top of the first coating and the third coating is applied on top of the second coating.
